(19) United States
(12) Patent Application Publication
(10) Pub. No.: US 2001/0046528 A1
(43) Pub. Date: Nov. 29, 2001

(54) Weighing system for furnish material used in the compression molding of cellulosic articles

(76) Inventors: Anthony Joseph Cline, Muscatine, IA (US); Stacy Bazal, Muscatine, IA (US); Christopher Patrick Schrauth, Muscatine, IA (US); Dallas Scott Calvelage, Muscatine, IA (US)

Correspondence Address: Ronald A. Sandler, Jones, Day, Reavis & Pogue, 77 West Wacker Drive, Chicago, IL, 60540, US

(21) Appl. No.: 09/802,271

(22) Filed: Mar. 8, 2001

Related U.S. Application Data
(60) Provisional application No. 60/188,567, filed on Mar. 10, 2000.

(51) Int. Cl. B29C 31/02

(52) U.S. Cl. 425/447

(57) ABSTRACT

A feed belt conveying and weighing system for a compression molding process includes a supply hopper which supplies wood furnish to a continuous conveyor belt that is preferably driven by a pneumatic motor controlled by a proportional valve. The conveyor dumps the furnish into a bin suspended by load cells connected to a summing box which measures out a desired quantity of furnish. Once a desired quantity of furnish is deposited in the bin, a slide gate opens at the bottom of the bin and furnish is discharged for further processing.

### CROSS REFERENCE TO RELATED APPLICATION

Priority is claimed from U.S. Provisional Application Serial No. 60/188,567, filed Mar. 10, 2000.

### BACKGROUND OF THE INVENTION

1. Field of the Invention

The present invention relates generally to compression molding of cellulosic articles and, more particularly, to a weighing system for furnish material used in the molding under heat and pressure of thermosetting resin coated wood fiber furnish which has been recycled from waste wood articles.

2. Description of the Related Art

It has long been known that synthetic products can be manufactured using a thermosetting binder, heat and pressure to reconsolidate refined cellulosic and/or lignocellulosic furnish materials into unitary rigid products. One common form of such products is particle board or fiberboard. The binders usually used in producing particle board, for example, are thermosetting resins such as urea-formaldehyde or phenol-formaldehyde. An example of a process for manufacturing such boards is disclosed in early U.S. Pat. No. 2,757,115 issued to Heritage. Basically, this patent teaches reducing a furnish material, such as wood, to fibers by a refiner, mixing the fibers with a binder and other chemicals such as release and sizing agents, forming the mixture into mats and compressing the mats between heated platens in a hot press to form board products of a desired thickness and density.

Waste disposal is an ever increasing concern to society. Although recycling efforts have been relatively successful with a variety of materials, certain materials have continually posed a problem as being generally non-recyclable. Examples of these hard-to-recycle materials include urban wood waste such as demolition waste from old buildings, wood chips generated from construction materials, old pallets and crates and the like.

Existing technology utilizes vibratory action to move wood furnish either across a pan or through a bin discharger, both of which would be located at the bottom of a surge bin. Either one of the previous technologies would meter quantities of wood into a scale. The problem with this technology is its inability to handle subtle variations in the wood furnish. The nature of the wood furnish used to make compression molded articles is such that it can be long, slender, hairy, and clings to itself. This type of material is very difficult to convey with the vibratory action. Other technology uses a weigh belt; however, this technology does not give a batch weight. The weigh belt rather determines flow rate across the belt conveyor. This system is commonly found in conjunction with a continuous mixer and forming head in a particle board plant. This works well on a continuous basis but it cannot weigh small batches of wood in a quick manner.

Accordingly, it is desirable to provide a process for recycling urban wood waste into useful synthetic wood-base products. Further, it is desirable to provide such a process which can produce molded articles of various shapes and contours, such as, for example, chair form products for manufacturing chair seats and backs. Still further it is desirable to provide a weighing system for the furnish used in the compression molding process that is highly efficient and cost-effective to construct.

### SUMMARY OF THE INVENTION

The present invention improves over the prior art by providing a feed belt conveying and weighing system for a compression molding process including a supply hopper which supplies wood furnish to a continuous conveyor belt that is preferably driven by a pneumatic motor controlled by a proportional valve. The conveyor dumps the furnish into a bin suspended by load cells connected to a summing box which measures out a desired quantity of furnish. Once a desired quantity of furnish is deposited in the bin, a slide gate opens at the bottom of the bin and furnish is discharged for further processing.

### BRIEF DESCRIPTION OF THE DRAWINGS

The foregoing and other novel features and advantages of the invention will be better understood upon a reading of the following detailed description taken in conjunction with the accompanying drawings wherein:

FIG. 1 is a side schematic view of a feed belt weighing system for conveying and weighing furnish material in a compression molding process as constructed in accordance with the principles of the invention; and

FIG. 2 is an end view thereof.

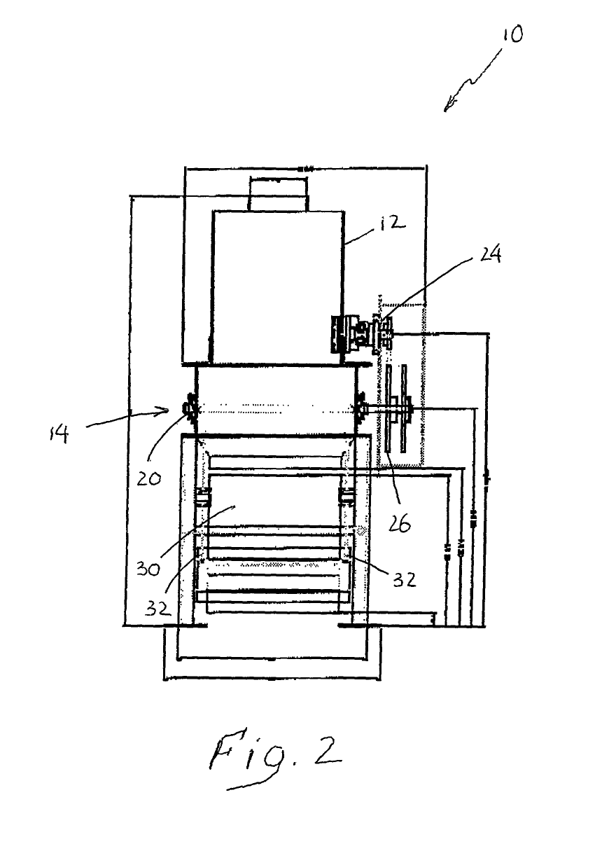

### DETAILED DESCRIPTION OF THE PREFERRED EMBODIMENT

Referring now to the drawings, a feed belt weighing system for conveying and weighing furnish material in a compression molding process as constructed according to the invention is designated generally by the reference numeral 10. The system 10 is particularly suitable for use in the molding of articles formed in a press under heat and pressure as disclosed in a related provisional application filed on even date herewith titled “Mold Ejection Apparatus for Use in Compression Molding of Cellulosic Articles,” the complete description of which is incorporated herein by reference in its entirety. The system 10 is designed to deliver a predetermined batch size of furnish to a mixer wherein the furnish, which in one form comprises strands of ground waste wood fiber, is mixed with a suitable thermosetting binder to be later conveyed to a mold press.

Wood furnish is supplied to the system 10 by any convenient conveying means and is first deposited in an upper hopper 12. The hopper 12 is preferably trapezoidal in shape to minimize material clinging to the hopper sidewalls. Preferably, the hopper 12 is also lined with a high molecular weight material to give the sidewalls a smooth finish. A belt feeder conveyor assembly 14 is attached to the bottom end of the hopper 12. The assembly 14 comprises a textured continuous belt 16 journaled by suitable rollers and bearings 18 and 20. A suitable tensioner 22 maintains proper tension on the belt. Also, to assist in conveying the wood furnish the belt may also be provided with a plurality of upstanding cleats, such as small sections of angle iron, to keep the furnish from slipping on the belt. The belt is preferably driven by a pneumatic motor and gear reducer assembly 24 and idler pulley 26 controlled by a proportional valve. The proportional valve and motor allows the belt feeder 14 to convey the material in a controlled manner. This leads to short batch times and good accuracy. Either an electric motor or a hydraulic system could replace the pneumatic motor.

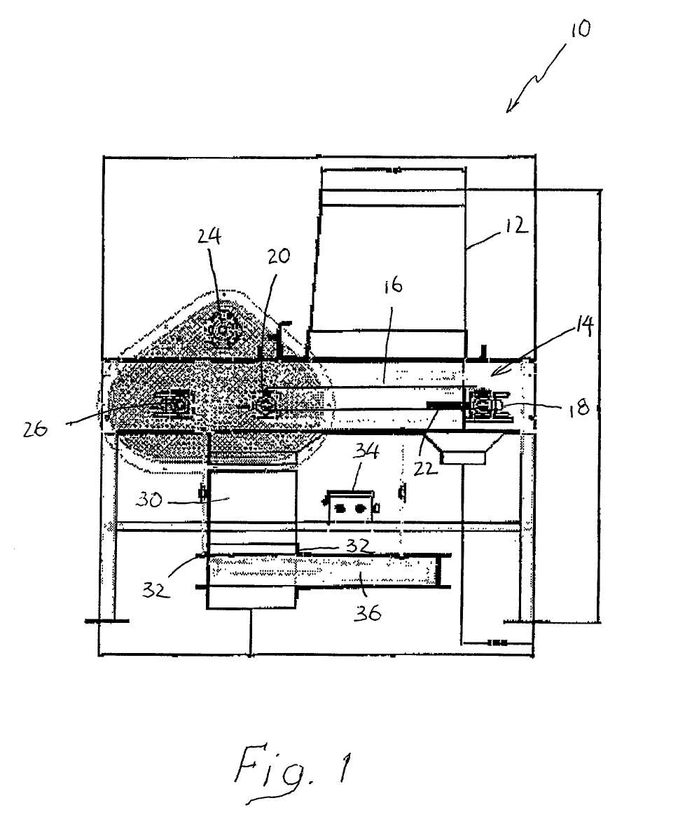

The belt feeder conveyor assembly 14 conveys the furnish in a direction to the left as viewed in FIG. 1 whereupon the furnish dumps into a weighing bin 30, which is essentially a rectangular box. In terms of scale, for forming chair seats and backs in a compression molding process the bin 30 is on the order os two cubic feet in capacity. Four load cells 32 suspend the bin 30 and are connected to a summing box 34 which in turn in connected to a system PLC. Once a desired amount of material is added to the weigh bin 30 a slide gate in the bottom of the bin opens by means of a pneumatic cylinder 36 and the batch of material is discharged from the bin 30. In one form of a compression molding process the discharged batch may drop into a mixer assembly (not shown) where it is mixed with suitable thermosetting resin.

It can now be appreciated that the system 10 of the present invention offers considerable advantages particularly over vibratory conveying and weigh belt system. The system 10 has particular application in conveying and weighing out small batches of ground wood fiber suitable to be used in a compression molding process.

While the present invention has been described in connection with preferred embodiments thereof, it will be apparent to those skilled in the art that many changes and modifications may be made without departing from the true spirit and scope of the invention. Accordingly, it is intended by the appended claims to cover all such changes and modifications as come within the spirit and scope of the invention.

What is claimed is:

1. A conveying and weighing system for wood furnish used in a compression molding process comprising:
a supply hopper configured to supply wood furnish to a continuous conveyor belt;
a bin suspended by load cells into which said furnish is deposited from said conveyor belt; and
a summing box connecting to said load cells for measuring a desired quantity of furnish.

2. The system of claim 1 wherein said belt is provided with a plurality of cleats to engage said furnish.

3. The system of claim 1 wherein said belt is driven by a pneumatic motor controlled by a proportional valve.

4. The system of claim 1 wherein said quantity of furnish is deposited into a mixer assembly to be mixed with a thermosetting resin.
